(19) United States
(12) Patent Application Publication
(10) Pub. No.: US 2018/0221997 A1
(43) Pub. Date: Aug. 9, 2018

(54) AGGLOMERATED WELDING FLUX AND SUBMERGED ARC WELDING PROCESS OF AUSTENITIC STAINLESS STEELS USING SAID FLUX

(71) Applicant: OERLIKON SCHWEISSTECHNIK GMBH, Eisenberg (DE)

(72) Inventor: STEPHEN STARCK, GRUENSTADT (DE)

(21) Appl. No.: 15/887,250

(22) Filed: Feb. 2, 2018

(30) Foreign Application Priority Data
Feb. 9, 2017 (EP) 17155471.0

(51) Int. Cl. B23K 35/362; B23K 35/02; B23K 35/30; C22C 38/58; C22C 38/48; C22C 38/44; C22C 38/02; C22C 38/00; B23K 9/18

(52) U.S. Cl. CPC B23K 35/362; B23K 35/0261; B23K 35/3086; C22C 38/58; B23K 2203/05; C22C 38/44; C22C 38/02; C22C 38/001; B23K 9/18; C22C 38/48

(57) ABSTRACT

One or more techniques and/or systems are disclosed for an agglomerated welding flux that can comprise, as expressed in % by weight of flux: 25 to 35% MgO, 20 to 28% CaF₂, 15 to 22% Al₂O₃, 12 to 17% SiO₂, and 0,2 to 0,4% carbon (% by weight). The carbon can be introduced using at least one metallic compound contained in the flux. Further disclosed is a process for submerged-arc welding of at least one workpiece made of austenitic stainless steel, using the described flux. Additionally disclosed is a welded joint that can comprise 17 to 20% Cr, 5 to 8,5% Mn, and 14 to 18% Ni, which can be obtained using the described process.

### CROSS-REFERENCE TO RELATED APPLICATIONS

This application claims priority to European Patent Application No. 17155471.0, filed on Feb. 9, 2017, entitled AGGLOMERATED WELDING FLUX AND SUBMERGED ARC WELDING PROCESS OF AUSTENITIC STAINLESS STEELS USING SAID FLUX, which is incorporated herein by reference.

### BACKGROUND

Austenitic stainless steels exhibit a combination of highly desirable properties that make them useful for a wide variety of industrial applications. These steels possess a balanced analysis of chromium and austenite promoting and stabilizing elements in iron and have an austenitic structure at room temperature. The austenitic structure and high chromium content both contribute to corrosion resistance and the relatively uniform austenitic structure also provides the steel with good strength and toughness properties, mainly due to the high contents of chromium (Cr), nickel (Ni) and manganese (Mn), which make them particularly attractive as construction materials.

In particular, austenitic stainless steels, having a typical Ni content of up to 9%, and a Chromium content of about 19% are especially suited for vessels which can be used at cryogenic temperatures, typically below −170° C. (−270° F.) for the storage of liquefied hydrocarbon gases (LNG) or liquefied air components like oxygen or nitrogen.

Nickel can be an expensive constituent, so there is a high interest to decrease the nickel content in austenitic stainless steel, but at the same time to maintain the possibility of its use for cryogenic purposes. An example of such a low-nickel austenitic stainless steel is the 201LN grade (ASTM A240 international standards).

A problem that can be faced, generally, is that if austenitic steel is SA welded (SA is a Submerged Arc welding process), the crystalline structure of the weld metal can be coarse, because of the very high amount of heat used in this process, and the tensile strength of the weld metal can be relatively lower as compared to that obtained with other welding processes.

However, the construction industry requires that the tensile strength (also called ultimate tensile strength) of the weld metal to be higher than the tensile strength of the base metal, and, in particular that the tensile strength of the weld metal be between 655 and 740 MPa at 20° C. The standard sets a lower tensile strength for ASTM 201LN at 655 MPa (95ksi). Tensile strength is important characteristic for the design of a pressure vessel. For a given design, the wall thickness is defined by the lower tensile strength. For economic reasons, the wall thickness is selected to be as low as practicable; hence, the plate material and the weld metal have to meet the lower tensile strength of the standard. In addition, there are requirements in terms of lower toughness of the weld metal, typically at least 47 J at −196° C. If these level requirements are not met, this can be deleterious to the integrity of the structures thus welded.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein can be utilized to provide an agglomerated welding flux. The proposed welding flux allows for a welded joint having the desired levels of tensile strength and toughness when welding a low-nickel austenitic stainless steel, using an SA welding process.

In one implementation an agglomerated welding flux can comprise, as expressed in percentage weight of flux: 25 to 35% magnesium oxide (MgO); 22 to 35% calcium fluoride (CaF₂); 15 to 22% aluminum oxide (Al₂O₃); 11 to 17% silicon dioxide (SiO₂), at least one metallic compound containing carbon (C); and 0,2 to 0,4% carbon (C), where the carbon can be introduced using the at least one metallic compound. In one implementation, the flux described herein may comprise one or more of the following features: the metallic compound can comprise 2 to 12% carbon (C); the flux can comprise 1,6 to 10% of the metallic compound; the metallic compound can be a ferroalloy; and the flux can comprise at least one metallic compound chosen among: ferrochromium, ferromanganese, cast iron, and silicium carbide powder.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

No drawings are necessary under 35 U.S.C. § 113 for the understanding of the subject matter sought to be patented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Typical ranges of contents for the metallurgical composition of such a low-nickel austenitic stainless steel, i.e. the composition of the base metal constituting this steel, is given in Table 1 below.

TABLE 1
Example Composition (in wt %) of the base metal 201LN (ASTM A24Q1)

| C | Mn | Si | Cr | Ni | N | Cu | S | P |
|---|---|---|---|---|---|---|---|---|
| 0.00 | 6.4 | 0.00 | 16 | 4.0 | 0.01 | 0.00 | 0.00 | 0.00 |
| to | to | to | to | to | to | to | to | to |
| 0.03 | 7.5 | 0.75 | 18 | 5.0 | 0.25 | 1.0 | 0.03 | 0.045 |

These example low-nickel austenitic stainless steels are conventionally welded by carrying out a submerged-arc welding (hereinafter called “SA welding”) processes using a welding flux and a wire which are melted by an electric arc, thus supplying filler metal so as to form the desired welded joint. The work pieces to be welded may be sheets, plates, forgings or pipes.

In a first aspect, the flux described herein relates to an agglomerated welding flux that comprises, as expressed in % by weight of flux:
25 to 35% magnesium oxide (MgO),
22 to 35% calcium fluoride (CaF₂),
to 22% aluminum oxide (Al₂O₃),
11 to 17% silicon dioxide (SiO₂),
at least one metallic compound containing carbon, and
0,2 to 0,4% carbon, where the carbon is introduced using the least one metallic compound.

Depending on the situation or desired use, the flux described herein may comprise one or more of the following features:
the metallic compound comprises 2 to 12% carbon.
the flux comprises 1,6 to 10% of the metallic compound,
the metallic compound is a ferroalloy, and
the flux comprises at least one metallic compound chosen among: ferrochromium, ferromanganese, cast iron, and silicium carbide powder.

In a second aspect, the inventive concept described herein can relate to a process for the submerged-arc (SA) welding of at least one workpiece made of austenitic stainless steel, in which a consumable wire and a flux are melted by an electric arc to obtain a welded joint on the at least one workpiece, characterized in that the flux is an agglomerated welding flux according to the flux described herein.

In one implementation, the consumable wire can comprise, as expressed in % by total weight of wire:
0,01 to 0,05% carbon (C),
0,1 to 1% silicon (Si),
5 to 9% manganese (Mn),
19 to 22% chromium (Cr),
15 to 18% nickel (Ni),
2,5 to 4,5% molybdenum (Mo),
0,1 to 0,2% nitrogen (N), and
iron (Fe) for the remaining portion.

In one implementation, the work piece may comprise, as expressed in % by weight of workpiece:
16 to 18% Cr,
6,4 to 7,5% Mn, and
4,0 to 5,0% Ni.

In one implementation, the workpiece may further comprise, as expressed in % by weight of workpiece:
0,01 to 0,03% C,
0,1 to 0,75 % Si,
0,01 to 0,025% N, and
iron (Fe) for the remaining portion.

In a third aspect, the inventive concept can relate to a welded joint that can be obtained by the welding process as described herein, characterized in that it can comprise, as expressed by weight of joint:
17 to 20 % Cr,
5 to 8,5% Mn, and
14 to 18% Ni.

In one implementation, the welding joint as described herein, can further comprise, as expressed in % by weight of workpiece:
0,09 to 0,13 % C,
0,3 to 0,7% Si,
2 to 4% Mo,
0,1 to 0,25% N, and
iron (Fe) for the remaining portion.

In this aspect, the welding joint may have a tensile strength of between 650 and 700 MPa at 20° C., and/or a lower toughness level of 27 J at −196° C.

In a fourth aspect, the inventive concept can relate to a workpiece made of austenitic stainless steel that comprises 16 to 18% Cr, 4,0 to 5,0% Ni, 6,4 to 7,5% Mn and iron, characterized in that it comprises at least one welded joint according as described herein.

As used herein, the term “agglomerated flux” is understood to mean that the flux is formed from particles or small granules predominantly composed of mineral substances, for example, aluminum oxide or silicon oxide, and possibly metal compounds in powder form to which a binder (or binders) is added based on an aqueous inorganic silicate, such as a sodium silicate. All substances including the possible powder like metal compounds can form the composition of the flux. All compounds and substances present can be agglomerated with one another and form the flux grains. The final flux grains can be predominantly round in shape and have a grain size comprised predominantly between 0,2 and 2,0 mm .

It should be noted that the carbon present in the flux can be analyzed by infrared absorption, while the elements Mg, Al, Si, F can be analyzed by XRF (X-ray fluorescence). The elements Mg and Al can be analyzed as well by ICP-AES; and F can be analyzed by ion sensitive electrodes after vapor extraction. As it is known that the elements such as Mg, Al and Si are present as oxides, they are usually expressed as oxides such as MgO, Al₂O₃ and SiO₂. As it is known that F is predominantly present as CaF it is expressed as CaF. Ca can be analyzed as well by XRF or ICP-AES (inductively-coupled plasma atomic emission spectrophotometry) and/or by ICP-MS (inductively-coupled plasma mass spectroscopy). Ca which can be stoichiometrically attributed to F is expressed as CaF₂. The remaining Ca is expressed as CaO. Si can be as well analyzed gravimetrically.

According to another aspect, the inventive concept can relate to a process for the submerged-arc (SA) welding of at least one work piece made of austenitic stainless steel, in which a consumable wire and a flux are melted by an electric arc to obtain a welded joint on said at least one workpiece, characterized in that the flux is described herein.

Depending on the situation, the welding process of described herein may comprise one or more of the following features:
A consumable wire comprising, as expressed in % by total weight of wire:
   0,01 to 0,05% carbon (C);
   0,1 to 1% silicon (Si);
   5 to 9% manganese (Mn);
   19 to 22% chromium (Cr);
   15 to 18% nickel (Ni);
   2,5 to 4,5% molybdenum (Mo);
   0,1 to 0,2% nitrogen (N); and
   iron (Fe) for the remaining portion.
A work piece comprising, as expressed in % by weight of workpiece:
   16 to 18% Cr;
   6,4 to 7,5% Mn; and
   4,0 to 5,0% Ni.
The workpiece can further comprise, as expressed in % by weight of workpiece:
   0,01 to 0,03% C;
   0,1 to 0,75 % Si;
   0,01 to 0,025% N; and
   iron (Fe) for the remaining portion.

In one implementation, the welding process described herein may use a consumable wire comprising, as expressed in % by total weight of wire:
Up to 0,03% carbon (C), or between 0,01% and 0,03% C,
Up to 1,0% silicon (Si), or between 0,1% and 1,0% Si,
5 to 9% manganese (Mn),
19 to 22% chromium (Cr),
15 to 18% nickel (Ni),
2,5 to 4,5% molybdenum (Mo),
1 to 0,2% nitrogen (N),
Up to 0,5% copper (Cu), or between 0,03% and 0,5% Cu
Up to 0,03% phosphorus (P), or between 0,005% and 0,03% P,
Up to 0,02% sulfur (S), or between 5 ppm and 0,02% S, and
iron (Fe) for the remaining portion.

Respective elements can be analyzed by OES (Optical Emission Spectrometry); C and S can be analyzed by infrared absorption. N can be analyzed by katharometry (thermal conductivity). Si can be analyzed as well gravimetrically; Mn, Cr, Ni, Mo can be as well analyzed by ICP-AES (inductively-coupled plasma atomic emission spectrophotometry).

According to another aspect, the inventive concept relates to a welded joint (e.g. the deposited weld metal) that can be obtained by implementing the SA welding process as described herein, characterized in that it comprises, as expressed by weight of joint:
A welded joint resulting from a welding process comprising submerged-arc welding of at least one workpiece made of austenitic stainless steel, in which a consumable wire and a flux are melted by an electric arc to obtain a welded joint on the at least one workpiece, where the flux comprises 25 to 35% magnesium oxide (MgO), 22 to 35% calcium fluoride (CaF2), 15 to 22% aluminum oxide (A1203), 11 to 17% silicon dioxide (SiO2), at least one metallic compound containing carbon, and 0,2 to 0,4% carbon, the carbon being introduced using the least one metallic compound, characterized in that the joint comprises, as expressed by weight of joint:
   17 to 20 % Cr;
   5 to 8,5% Mn; and
   14 to 18% Ni.

In one implementation, the welded joint of the invention may comprise one or more of the following features:
The welded joint can further comprises, as expressed in % by weight of joint:
   0,09 to 0,13 % C,
   0,3 to 0,7% Si,
   2 to 4% Mo,
   0,1 to 0,25% N, and
   iron (Fe) for the remaining portion.
The welded joint can comprise a tensile strength of between 650 and 700 MPa at 20° C.
The welded joint can comprise a lower level of toughness of 27 J at negative 196° C.

The chemical analysis of the deposited metal can be carried out on the axis of the joint. The carbon may be analyzed by infrared absorption, the nitrogen by katharometry, the manganese, chromium, molybdenum and nickel by OES (optical emission spectroscopy) and the other elements by ICP-AES and/or ICP-MS. Silicon can be analyzed gravimetrically.

According to another aspect, the inventive concept can relate to a workpiece made of austenitic stainless steel. In one implementation, the workpiece can comprise 16 to 18% Cr, 4,0 to 5,0% Ni, 6,4 to 7,5% Mn and iron, characterized in that it comprises at least one welded joint as described herein. In one implementation, the workpiece can comprise a pipe, a plate or a forging.

The inventive concept described herein may be better understood by virtue of the following explanations dealing with the influence of the various elements present in flux (all % expressed by weight).

### Magnesium Oxide (MgO)

MgO can increase the viscosity of the slag and can allow obtaining a uniform bead. In addition, it can help control the oxygen content in the weld metal. A MgO content lower than 25% in the flux can increase the oxygen content and the toughness of the weld metal. On the other hand, a MgO content higher than 35% may lead to an unstable arc, a non-uniform bead and a poor slag removal.

### Calcium Fluoride (CaF₂

CaF₂ can allow obtaining a uniform bead and can control the quantity of hydrogen and oxygen that may diffuse in the weld metal. When the CaF₂ content is lower than 20%, the toughness may decrease due to a higher oxygen content in the weld metal. On the other hand, when the CaF₂ content is higher than 28%, the arc is may be unstable, the form of the bead may be bad, and the slag removal is can be poor.

Aluminum Oxide (Al₂O_{R})

Al₂O₃ can improve the fluidity of the slag and the bead uniformity. An Al₂O₃ content lower than 15% may have little effect on these improvements, whereas a Al₂O₃ content higher than 22% may decrease the toughness due to a higher oxygen content in the weld metal.

### Silicon Dioxide (SiO₂)

SiO₂ can improve the fluidity of the slag and the bead uniformity. A SiO₂ content lower than 12% may have little effect on these improvements. But when the SiO₂ content is higher than 17%, the toughness properties may be degraded due to the higher oxygen content in the weld metal.

### Carbon (C)

Carbon can be added to the flux to facilitate high tensile properties of the weld metal. As described herein, carbon can be introduced using at least one carbon-containing metallic compound in the flux. Hence, during the SA welding process, the carbon may be transferred in the weld metal so as to increase the tensile strength of the weld metal.

The introduction of carbon in the metallic form can be desirable because carbon may not decompose during the flux baking process. The at least one metallic compound, described herein, can be used as a source of carbon to transfer the carbon into the weld pool, in a desired quantity, and in a more predictable way. In contrast, compounds that are not in the metallic form, for example graphite (C), may decompose during the baking process and hence may not transfer carbon in a predictable way and in the desired quantity.

An elevated content level of C in the joint, i.e. in the deposited metal, can lead to a hardened structure of the martensite type, and/or to an excessive amount of carbide precipitates, which can harden the structure, resulting in undesired toughness characteristics. Alternately, a low level of C content may result in insufficient tensile mechanical properties. Hence, it is desirable to have an amount of C in the flux, of between 0,2 and 0,4%.

In one implementation, the at least one metallic compound can comprise a ferroalloy, which may be chosen from the group including: ferromanganese, ferrochromium, cast iron powder, and silicium carbide powder. For example, the use of a ferroalloy is desirable because the ferroalloy may not decompose during the flux baking process. The carbon containing ferroalloy acts a C source to transfer the carbon into the weld pool in a more predictable way. In contrast, graphite (C) can decompose during the baking process and hence may not transfer carbon in a predictable way. Carbonates like calcium carbonate (CaCO₃) also contain carbon, but, during the welding process, they can decompose into a metal oxide like CaO, and a mixture of CO and CO2. Both components are disposed in a gaseous form, which may not allow for the transfer carbon into the weld pool in the desired quantity.

In this inventive concept, a ferroalloy can refer to an alloy with more than 1% of carbon, and one or more other elements, such as iron, manganese, chromium, or silicon. As an example, the use of a ferroalloy comprising less than 2% carbon may result in an increased use of the ferroalloy in the flux, typically greater than 10%. If more than 20% of a ferroalloy is added to a flux the resulting welding properties of the flux may be very poor.

In one implementation, the ferroalloy can comprise a carbureted ferroalloy (“ferroalliage carbure” in French), having a high carbon content, for example, 4 to 12% carbon, or between at least 5% carbon and less than 10% carbon (% by weight). For example, a higher the carbon content inside the alloy can provide for less of the resulting component to be used. Further, a lower alloy addition can provide improved welding properties. Alternately, if the carbon content of the alloy exceeds 12%, the graphite may precipitate inside the alloy; and, the use of an alloy that is ground to very fine powder may result in graphite inside the mixture. However, graphite is not typically desirable because it can oxidize during the baking process. Resulting in a welding process that has become unpredictable.

The ferroalloy may be a carbureted ferromanganese (“ferromanganese carbure” in French), also called high-carbon ferromanganese. In one implementation, the ferromanganese can comprise 75 to 80% Mn and 5 to 9% C, or between 6 to 8% C (% by weight). The ferroalloy may also be a carbureted ferrochromium (“ferrochrome carbure” in French), containing 64 to 90% Cr and 4 to 12% C, or between 6 to 9% C (% by weight).

According to another embodiment of the invention, the at least one carbon-containing metallic compound may be cast iron powder. In one implementation, the cast iron powder can contain 2 to 4% carbon (% by weight). Cast iron can offer the advantage of having no additions of chromium or manganese.

According to another embodiment of the invention, the at least one metallic compound may be silicium carbide.

In one implementation, the SA welding process, as described herein, can be carried out by melting a flux, as described above, and a welding wire having the following composition (weight %):
0,01 to 0,05% carbon (C),
0,1 to 1% silicon (Si),
5 to 9% manganese (Mn),
19 to 22% chromium (Cr),
15 to 18% nickel (Ni),
2,5 to 4,5% molybdenum (Mo),
0,1 to 0,2% nitrogen (N), and
iron (Fe) for the remaining portion.

The influence of the various elements present in the wire is explained below (respective contents are expressed as % relative to the total weight of wire).

### Carbon (C)

Carbon can be introduced to improve the strength of the weld metal.

### Chromium (Cr) and Molybdenum (Mo)

The elements Cr and Mo can be the main alloying elements of high strength austenitic stainless steels. The elements Cr and Mo can combine with the carbon of the steel to form carbides that give the steel strength, and therefore also give strength to the weld metal. An excess amount of Cr or Mo in the weld metal may cause a deterioration in the toughness properties of the weld metal. Hence measures can be taken to provide desired amounts in the joint, such as an amount of Cr between 16 and 22%, and an amount of Mo of up to 4,5 wt %.

### Silicium (Si)

Silicon can act as a deoxidizing agent in the weld metal. It can be present in a sufficient amount in order to help control the oxygen (0) content. If the Si content is too high, the toughness properties may be degraded. Thus, a desired amount of Si in the joint can be within the range from 0,3 to 1%.

### Nickel (Ni)

The addition of nickel can have the effect of promoting the austenitic structure. For this reason, the desired Ni level can be between 15 and 18%.

### Nitrogen (N)

The nitrogen can have the effect of promoting the austenitic structure and to improve strength. An excess amount of nitrogen can result in weld metal porosity, which is not desirable for acceptance by most of construction codes. A desired N content can be less than 0,25% and typically comprised between 0,14 and 0,2%.

### Illustrative Examples

The examples given below can show that, when an SA welding process is carried out on workpieces made of austenitic stainless steel using a flux as described herein, a weld joint can be obtained that has a metallurgical composition as described herein, such as a joint for which the desired tensile strength for the construction industry is achieved, as well as good toughness properties.

The tensile strength of the joint specimens was evaluated by means of tensile tests carried out at a temperature of 23° C. and ultimate tensile strength measurements. The ultimate tensile strength is measured by the maximum stress that a material can withstand while being stretched or pulled before breaking. The toughness of the specimens was also measured using the Charpy V-notch test, which is a standardized high strain-rate test which determines the amount of energy absorbed by a material during fracture. This test was carried out at a temperature of negative 196° C.

The tensile and toughness tests were carried out on specimens machined from deposited metal from the center of the weld joint. The low-nickel austenitic steel workpieces on which the weld metal was deposited were made of the 201LN grade (ASTM A240), and had the composition given in Table 2 below.

TABLE 2
Composition (in wt %) of the tested base metal

| c | Mn | Si | Cr | Ni | Mo | N | Fe |
|---|---|---|---|---|---|---|---|
| 0.026 | 7.2 | 0.38 | 16.2 | 4.7 | 0.23 | 0.12 | rest |

The fluxes (flux 1, flux 2, flux 3) used in the SA welding had the compositions given in Table 3 below. Carbon was introduced in the flux using carbureted ferrochromium and carbureted ferro-managnese as a carbon-containing metallic compound. The flux 1 contained an amount of 2% ferrochromium and 2% of carbureted ferromanganese The flux 2 contained an amount of 2,5% ferrochromium and 2% of carbureted ferromanganese. This carbureted ferrochromium compound comprised 64 to 70% Cr and 9 to 10% C. The carbureted ferromanganese compound comprised 75 to 80% of manganese and 6 to 7,7% of carbon.

TABLE 3
Composition (in wt %) of the tested fluxes

| | Flux 1 | Flux 2 | |
|---|---|---|---|
| | (wt %) | (wt %) | |
| Chemical | Subject of | Subject of | |
| element | this invention | this invention | Flux 3 (wt %) |
| MgO | 30.6 | 30.1 | 33.0 |
| CaF₂ | 24.5 | 24.5 | 24.9 |
| Al₂O₃ | 16.0 | 16.0 | 16.1 |
| SiO₂ | 13.0 | 13.0 | 13.5 |
| C | 0.30 | 0.38 | 0.0 |
| CaO | 8 | 8 | 8 |
| MnO | 3 | 3 | 2.5 |
| Na₂O | 1 | 1 | 1 |
| K₂O | 2 | 2 | 2 |
| Cr₂O₃ | 1.6 | 2.0 | 0.0 |

TABLE 4
Composition (in wt %) of the tested wires

| Chemical | | | | | | |
|---|---|---|---|---|---|---|
| element | Wire 1 | Wire 2 | Wire 3 | Wire 4 | Wire 5 | Wire 6 |
| C | 0.026 | 0.025 | 0.021 | 0.042 | 0.013 | 0.05 |
| Mn | 7.4 | 6.8 | 1.8 | 1.4 | 1.51 | 5.8 |
| Si | 0.46 | 0.35 | 0.42 | 0.55 | 0.51 | 0.45 |
| Cr | 19.8 | 23.5 | 18.5 | 18.9 | 22.9 | 17.6 |
| Ni | 16.1 | 22.1 | 11.5 | 9.4 | 8.6 | 7.5 |
| Mo | 3.1 | 3.0 | 2.7 | 0.05 | 3.0 | 0.02 |
| Nb | 0.017 | 0.014 | 0.012 | 0.40 | 0.020 | 0.01 |
| N | 0.22 | 0.28 | 0.05 | 0.04 | 0.14 | 0.01 |

In this implementation, the specimens of deposited metal away from any dilution were obtained by applying the following SA welding parameters:
SA welding with wires having a diameter of 3,2 mm, the compositions of which are in Table 4, associated with fluxes 1, 2, 3 of Table 3,
preheating between 25 and 100° C.
8 to 12 welding passes,
temperature of the base metal between the welding passes of about 100° C.,
welding energy of about 1,5 kJ/mm for a welding speed of 55 cm/min, and
DC+ current of 460 A at 30 V, -cooling time of the weld metal from 800° C. to 500° C. of between 7 and 17 s.

Cylindrical tensile specimens were machined longitudinally in the deposited metal, i.e. in the resulting weld joints. The total length of the specimens was 97 mm; the diameter of the gauged part was 10 mm and the length of the gauged part was 50 mm.

Each tensile test was carried out at 23° C. The pull rate was 15MPa/s.

The composition of the tested specimens (in wt % of each element) and the results of tensile strength (Rm, expressed in MPa) and toughness measurements (Kv, expressed in Joules, at negative 196° C.) are given in Table 5 below.

TABLE 5
Composition of the tested welded joints and experimental results

| Weld No. | | C | Mn | Si | Cr | Ni | Mo | Nb | N | Rm | Kv |
|---|---|---|---|---|---|---|---|---|---|---|---|
| 1 | Flux 1 | 0.115 | 7.2 | 0.54 | 19.3 | 15.1 | 2.7 | 0.014 | 0.18 | 655 | 58 |
| | Wire 1 | | | | | | | | | | |
| 2 | Flux 2 | 0.12 | 7.4 | 0.55 | 20.0 | 16.0 | 2.7 | 0.014 | 0.18 | 680 | 60 |
| | Wire 1 | | | | | | | | | | |
| 3 | Flux 3 | 0.03 | 6.5 | 0.43 | 23.1 | 22.1 | 3.0 | 0.014 | 0.27 | 600 | 62 |
| | Wire 2 | | | | | | | | | | |
| 4 | Flux 3 | 0.02 | 1.5 | 0.55 | 18.0 | 11.5 | 2.7 | 0.012 | 0.05 | 590 | 28 |
| | Wire 3 | | | | | | | | | | |
| 5 | Flux 3 | 0.04 | 1.4 | 0.6 | 18.5 | 9.3 | 0.05 | 0.40 | 0.04 | 610 | 47 |
| | Wire 4 | | | | | | | | | | |
| 6 | Flux 3 | 0.03 | 1.4 | 0.6 | 22.4 | 8.6 | 3.0 | 0.023 | 0.14 | 792 | 20 |
| | Wire 5 | | | | | | | | | | |
| 7 | Flux 3 | 0.05 | 5.6 | 0.5 | 17.3 | 7.4 | 0.01 | 0.01 | 0.01 | 630 | 25 |
| | Wire 6 | | | | | | | | | | |

As can be seen in these examples, the exhibits corresponding to welds Nos. 1 and 2 gave appropriate results in terms of tensile strength and toughness properties. This is because an adapted content of carbon was added to the weld metal in order to increase the strength. An elevated C content can impair toughness results. These welds offered a desirable compromise between strength and toughness.

It may also be noted that Flux 2 gave better results in terms of strength and toughness than Flux 1, however the appearance of the resulting weld was not as desirable. In weld No 3, the tensile strength was undesirably low, because C was below 0,09%; the higher chromium and nickel contents compared to weld No 1 and 2 did not help to achieve the appropriate strength level.

Weld No 4 was similar to weld No 3: similar level of C but less Cr and 11,5% Ni, and as a consequence, more Fe. However the strength level was even lower which can illustrate that a desirable level of chromium and nickel may be identified.

Weld No 5 included 0,4% niobium (Nb) from the wire; however, the strength level remained less than desired, again because C was outside the appropriate range.

Weld No 6 included a change in the balance between chromium and nickel. That amount of chromium was at a higher level, and the amount of nickel was at a relatively low level. In this weld, high strength was obtained but an undesirable level of toughness.

Weld No 7 had, regarding chromium, nickel and carbon, a composition similar to weld no. 5; however the Mn content was increased by way of the wire, to 5,6%. This wire has no niobium (Nb) addition. The metal toughness remained below desired levels, and the toughness was also below desired levels.

The word “exemplary” may be used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure has been shown and described with respect to one or more implementations, equivalent alterations and modifications will occur to others skilled in the art based upon a reading and understanding of this specification, including any drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. An agglomerated welding flux comprising, as expressed in % by weight of flux:
25 to 35% magnesium oxide (MgO);
22 to 35% calcium fluoride (CaF₂);
15 to 22% aluminum oxide (Al₂O₃);
11 to 17% silicon dioxide (SiO₂);
at least one metallic compound containing carbon; and
0,2 to 0,4% carbon, the carbon being introduced using the least one metallic compound.

2. The flux of claim 1, the metallic compound comprising 2 to 12% carbon.

3. The flux of claim 1, comprising 1,6 to 10% of the metallic compound.

4. The flux of claim 1, the metallic compound comprising a ferroalloy.

5. The flux of claim 4, the ferroalloy comprising from 4 to 12% carbon by weight of the ferroalloy.

6. The flux of claim 1, the at least one metallic compound chosen from among the group consisting of: ferrochromium, ferromanganese, cast iron, silicium carbide powder.

7. The flux of claim 7, the cast iron comprising a cast iron powder comprising from 2 to 4% carbon by weight of the powder.

8. The flux of claim 1, comprising flux grains that are substantially round in shape and have a grain size comprised substantially from 0,2 to 2,0 mm.

9. A process for the submerged-arc welding of at least one workpiece made of austenitic stainless steel, in which a consumable wire and a flux are melted by an electric arc to obtain a welded joint on the at least one workpiece, characterized in that the flux is an agglomerated welding flux comprising, as expressed in % by weight of flux:
25 to 35% magnesium oxide (MgO);
22 to 35% calcium fluoride (CaF₂);
15 to 22% aluminum oxide (Al₂O₃);
11 to 17% silicon dioxide (SiO₂);
at least one metallic compound containing carbon; and
0,2 to 0,4% carbon, the carbon being introduced using the least one metallic compound.

10. The process of claim 9, the consumable wire comprising, as expressed in % by total weight of wire:
0,01 to 0,05% carbon (C);
0,1 to 1% silicon (Si);
5 to 9% manganese (Mn);
19 to 22% chromium (Cr);
15 to 18% nickel (Ni);
2,5 to 4,5% molybdenum (Mo);
0,1 to 0,2% nitrogen (N); and
iron (Fe) for the remaining portion.

11. The process of claim 9, the consumable wire comprising, as expressed in % by total weight of wire:
0,01 to 0,03% carbon (C);
0,1 to 1% silicon (Si);
5 to 9% manganese (Mn);
19 to 22% chromium (Cr);
15 to 18% nickel (Ni);
2,5 to 4,5% molybdenum (Mo);
0,1 to 0,2% nitrogen (N);
0,03 to 0,5% Copper (Cu);
0,005 to 0,03% phosphorus (P);
5 parts per million (PPM) to 0,02% sulfur (S); and
iron (Fe) for the remaining portion.

12. The process of claim 9, the work piece comprising, as expressed in % by -eight o workpicce:
16 to 18% Cr;
6,4 to 7,5% Mn; and
4,0 to 5,0% Ni.

13. The process of claim 12, the workpiece further comprises, as expressed in % by weight of workpiece:
0,01 to 0,03% C;
0,1 to 0,75% Si;
0,01 to 0,025% N; and
iron (Fe) for the remaining portion.

14. The process of claim 9, the consumable wire comprising a diameter of 3,2 mm.

15. A welded joint resulting from a welding process comprising submerged-arc welding of at least one workpiece made of austenitic stainless steel, in which a consumable wire and a flux are melted by an electric arc to obtain a welded joint on the at least one workpiece, where the flux comprises 25 to 35% magnesium oxide (MgO), 22 to 35% calcium fluoride (CaF₂), 15 to 22% aluminum oxide (Al₂O₃), 11 to 17% silicon dioxide (SiO₂), at least one metallic compound containing carbon, and 0,2 to 0,4% carbon, the carbon being introduced using the least one metallic compound, characterized in that the joint comprises, as expressed by weight of j oint:
17 to 20% Cr;
5 to 8,5% Mn; and
14 to 18% Ni.

16. The welded joint of claim 15, further comprises, as expressed in % by weight of the joint:
0,09 to 0,13% C,
0,3 to 0,7% Si,
2 to 4% Mo,
0,1 to 0,25% N, and
iron (Fe) for the remaining portion.

17. The welded joint of claim 15, comprising a tensile strength of between 650 and 700 MPa at 20° C.

18. The welded joint of claim 15, comprising a lower level of toughness of 27 J at negative 196° C.

19. The welded joint of claim 15, the workpiece is made of austenitic stainless steel comprising 16 to 18% Cr, 4,0 to 5,0% Ni, 6,4 to 7,5% Mn and iron.

20. The process of claim 19, the workpiece further comprising, as expressed in % by weight of workpiece:
0,01 to 0,03% C;
0,1 to 0,75% Si; and
0,01 to 0,025% N.
